(19) United States
(12) Patent Application Publication
(10) Pub. No.: US 2026/0298431 A1
(43) Pub. Date: Oct. 1, 2026

(54) LIGHT MODULE FOR A VEHICLE LIGHTING DEVICE

(71) Applicant: VALEO VISION, Bobigny (FR)

(72) Inventors: Sergio DONOSO, Martos (ES); Carlos-Rafael MARCOS, Martos (ES)

(73) Assignee: VALEO VISION, Bobigny (FR)

(21) Appl. No.: 18/998,172

(22) PCT Filed: Jul. 28, 2023
(86) PCT No.: PCT/EP2023/071005

§ 371 Date: Jan. 24, 2025

(30) Foreign Application Priority Data
Jul. 28, 2022 (FR) FR2207769

(51) Int. Cl. F21S 41/255

(52) U.S. Cl. CPC F21S 41/255

(57) ABSTRACT

The present invention relates to a motor vehicle light module configured so as to emit a first light function and a second light function non-simultaneously, and includes a projection optical element formed of a plurality of projection optical systems, a plurality of light units, each light unit including at least one light assembly, and a projection system belonging to the plurality of projection optical systems and receiving the light rays emitted by the light assembly or assemblies of the corresponding light unit. The light units being arranged such that each projection system of the projection optical element is illuminated when the first light function is emitted and when the second light function is emitted.

### TECHNICAL FIELD

The present invention relates to the field of automotive-vehicle luminous devices, and relates more particularly to a luminous module that is able to be incorporated into such luminous devices.

### BACKGROUND OF THE INVENTION

The field of lighting for automotive vehicles is subject to regulations that require each automotive vehicle to be able to carry out illumination functions that comply with specific safety standards. More particularly, the automotive vehicle is equipped with one or more luminous modules dedicated to carrying out each of these functions within each of these modules, at least one light source which is supplied with power in order to emit light rays, and at least one optical projection system, such as a lens or a mirror, configured to form a regulatory luminous or signaling light beam from the light rays emitted by the light source.

For reasons of space in particular, it is desirable to equip an automotive vehicle with a headlamp within which one or more luminous modules are able to generate several light functions, and in particular two different illumination functions, including a low beam function and a high beam function.

Low beams allow an automotive vehicle to be seen by other road users and allow its driver to see the roadway ahead out to a distance of 30 meters, without dazzling other users on the road. High beams emit light beams with a greater range so that the driver of the automotive vehicle can see the roadway properly out to a distance of at least 100 meters, under nighttime conditions.

The low beams are generated by projection of a light beam formed on the basis of light rays emitted by light sources specifically dedicated to the formation of these low beams.

The high beams consist of a light function distinct from the light function formed by the low beams. Specifically, the luminous module implements one or the other of the functions, but never both functions at the same time.

The high beams may be independent of the low beams, being generated by projection of a light beam formed on the basis of light rays emitted by light sources specifically dedicated to the formation of these high beams, or they may be generated by projection of a light beam complementary to that for forming the low beams, this complementary light beam being formed on the basis of light rays emitted by light sources disposed in a complementary manner to the light sources specifically dedicated to the formation of the low beams.

The means for creating the low beams and the high beams may be grouped together into one and the same luminous module disposed on the front face of an automotive vehicle, in particular to facilitate the creation of optical continuity when switching from the low beams to the high beams.

It is thus known to provide, within such a luminous module, a plurality of luminous units comprising at least one light source and a collector for shaping the light rays emitted by the light source, and an optical projection system for projecting the light beam shaped by the collector. The luminous units thus make it possible to create one or the other of the light functions.

However, such a configuration has the defect of causing differences in light signatures between the light functions emitted, meaning that the light emitted by each light function does not exit the luminous module through the same zones. For example, the optical projection systems of the luminous module are not always illuminated by each of the light functions. Thus, it is possible that, when one of the light functions is emitted, for example the low-beam function, one of the projection systems is not illuminated, and remains dark, while when the other light function is emitted, for example the high-beam function, this projection system is illuminated.

### SUMMARY OF THE INVENTION

The present invention falls within this context and is targeted at a luminous module that makes it possible to generate two separate light functions that make it possible to generate a uniform light signature between the two separate light functions. More particularly, the luminous module according to the invention is an automotive-vehicle luminous module configured to emit a first light function and a second light function in a non-simultaneous manner, and comprising
an optical projection element formed of a plurality of optical projection systems,
a plurality of luminous units, each luminous unit comprising:
at least one luminous assembly, and
an optical projection system that belongs to said plurality of optical projection systems and receives the light rays emitted by the luminous assembly or assemblies of the corresponding luminous unit,
the luminous units being arranged such that each optical projection system of said optical projection element is illuminated when the first light function is emitted and when the second light function is emitted.

According to the invention, a luminous module is thus provided that is configured to generate two separate light functions, wherein the exit surface is illuminated in an equivalent manner regardless of the light function implemented.

It should be understood that, according to the invention, each of the optical projection systems involved in forming the optical projection element by juxtaposing them next to one another is illuminated when the first light function is emitted, and that this illumination is brought about only by the first light function. Similarly, each optical projection system is illuminated when the second light function is emitted, and this illumination is brought about only by the second light function. Where appropriate, the second light function may be created by employing luminous means complementary to those employed to create the first light function.

In particular, each of the optical projection systems may be wholly illuminated when the first light function is emitted, and when the second light function is emitted. The term “wholly” may in particular mean that at least 90% of the optical surface of the optical projection system is illuminated by light rays when the first light function is emitted and, respectively, when the second light function is emitted.

Thus, advantageously, according to the invention, the luminous module does not have an ambient light source, which would have the function only of illuminating one or more optical projection systems of the optical projection element without being involved in one and/or the other of the first and second light functions, and which would be used to artificially fill a zone of an optical projection system that is not illuminated when the first light function and/or when the second light function is emitted.

Each luminous assembly has at least one light source which is activated when the light function or one of the light functions in which it is involved is implemented. Where appropriate, the luminous assembly also has an optical device having, for example, a collector with a reflective surface.

The light source emits a plurality of light rays mainly in the direction of the optical device and of its reflective surface. In particular, the optical device may have a shape exhibiting symmetry of revolution, elliptical or parabolic, centered on the optical axis of the optical projection system, in order to reflect the light rays in the direction of the optical projection system, irrespective of the point of incidence of the light ray on the reflective surface.

The reflected light rays then propagate as a light beam to the optical projection system along a propagation direction that is mainly longitudinal, parallel to the direction of the optical axis of the optical projection system. The latter projects the light beam onto the road by forming or helping to form a light beam projected onto the road.

The luminous module according to the invention may adopt several configurations that all implement the abovementioned features according to which the luminous units are arranged such that each optical projection system of said optical projection element is illuminated when the first light function is emitted and, respectively, when the second light function is emitted.

According to one feature of the invention, a partition is disposed between two adjacent luminous units. This partition forms a separating wall for the light rays, in order that the light rays emitted by one of the two luminous units does not reach the other of the two luminous units, and in particular does not reach the optical projection system of the other of the two luminous units, and vice versa. Each partition extends along the main propagation axis of the rays between the two adjacent luminous units, from the luminous assemblies of each of these units to the optical projection element.

According to one feature of the invention, the optical projection system of each luminous unit is formed by a projection mirror.

According to an alternative feature of the invention, the optical projection system of each luminous unit is formed by a projection lens. In particular, the projection lenses are juxtaposed and form an optical projection unit, said optical projection unit forming the optical projection element. This optical projection unit may be transparent and in one piece.

According to one feature of the invention, the optical projection unit has, on the opposite side from the luminous assemblies, a continuous and smooth exit face formed by the continuity of the external faces of the projection lenses. In this application, “smooth” is understood to mean a zone that is derivable at any point, in other words a zone that does not have a projecting or re-entrant edge. A portion is smooth if all the points forming it conform to this definition.

The optical projection unit also has an entry face facing the luminous assemblies and formed successively by the internal faces of the projection lenses. This entry face is continuous. Where appropriate, the entry face has successive undulations corresponding to the internal faces of the projection lenses.

According to a first variant of a first embodiment, the automotive-vehicle luminous module is particular in that the plurality of luminous units comprises a first luminous unit and an additional luminous unit,
the at least one luminous assembly of the first luminous unit comprising:
   a first luminous assembly formed of at least one first light source and of a first optical device designed to receive light rays emitted by the first light source and to form a first light beam from these light rays,
   a second luminous assembly formed of at least one second light source and of a second optical device designed to receive light rays emitted by the second light source and to form a second light beam from these light rays,
and the optical projection system of the first luminous unit, referred to as first optical projection system, being designed to project the first light beam as a first projected beam and the second light beam as a second projected beam;
the at least one luminous assembly of the additional luminous unit comprising:
   a first additional luminous assembly formed of at least one first additional light source and of a first additional optical device designed to receive light rays emitted by the first additional light source and to form a first additional light beam from these light rays,
and the optical projection system of the additional luminous unit, referred to as additional optical projection system, being designed to project the first additional light beam as a first additional projected beam,
the combination of the first projected beam and of the first additional projected beam forming the first light function, and the combination of the first projected beam, of the first additional projected beam and of the second projected beam forming the second light function.

This first variant of the first embodiment is intended, in particular, to cover luminous modules in which the second light function is not obtained independently of the first light function, but by complementarity of the first beam or beams contributing to the first light function with at least one second beam, which has, in the second light function, a shape complementary to that of the first beams. As a result, the means used to contribute to the creation of the first light function remain active when the means used specifically to contribute to the creation of the second light function are active. When, within the first luminous unit or within the additional luminous unit, the means used to contribute to the creation of the first light function are active, the optical projection system associated with this unit is illuminated, and the additional use of the specific means for the creation of the second light function makes it possible, of course, to maintain this illumination. Where appropriate, the additional use of the specific means for the creation of the second light function makes it possible to increase the surface area of the illuminated surface of the optical projection system. For example, the illuminated surface area may extend beyond the value of 90% mentioned above as an arbitrary threshold value for defining the term “wholly”.

It is notable that, in this first embodiment, the fact that the specific means for the creation of the second illumination function, i.e. the means that are only dedicated to this effect, are not used does not prevent illumination of the optical projection system.

In other words, in this first variant of the first embodiment, each luminous unit which comprises a luminous assembly that helps to generate a second light beam in the direction of the optical projection system that is part of this luminous unit also comprises a luminous assembly that helps to generate a first light beam in the direction of this optical projection system.

According to a second variant of the first embodiment, the additional luminous unit also comprises a second additional luminous assembly formed of at least one second additional light source and of a second additional optical device designed to receive light rays emitted by the second additional light source and to form a second additional light beam from these light rays,
and the optical projection system of the additional luminous unit, referred to as additional optical projection system, being designed to project the second additional light beam as a second additional projected beam,
the second additional projected beam being combined with the combination of the first projected beam, of the first additional projected beam and of the second projected beam in order to form the second light function.

In this second embodiment variant of the first embodiment, the second light function is not obtained independently of the first light function, but by complementarity of the first beam or beams contributing to the first light function with at least one second beam, which has, in the second light function, a shape complementary to that of the first beams. The functioning of the first embodiment described above thus applies equally.

According to a second embodiment, the automotive-vehicle luminous module is particular in that the plurality of luminous units comprises a first luminous unit and an additional luminous unit,
the at least one luminous assembly of the first luminous unit comprising:
   a first luminous assembly formed of at least one first light source and of a first optical device designed to receive light rays emitted by the first light source and to form a first light beam from these light rays,
   a second luminous assembly formed of at least one second light source and of a second optical device designed to receive light rays emitted by the second light source and to form a second light beam from these light rays,
and the optical projection system of the first luminous unit, referred to as first optical projection system, being designed to project the first light beam as a first projected beam and the second light beam as a second projected beam;
the at least one luminous assembly of the additional luminous unit comprising:
   a first additional luminous assembly formed of at least one first additional light source and of a first additional optical device designed to receive light rays emitted by the first additional light source and to form a first additional light beam from these light rays,
   a second additional luminous assembly formed of at least one second additional light source and of a second additional optical device designed to receive light rays emitted by the second additional light source and to form a second additional light beam from these light rays,
and the optical projection system of the additional luminous unit, referred to as additional optical projection system, being designed to project the first additional light beam as a first additional projected beam and the second additional light beam as a second additional projected beam,
the combination of the first projected light beam and of the first additional projected light beam forming the first light function, and the combination of the second projected beam and of the second additional projected beam forming the second light function.

This second embodiment is intended, in particular, to cover luminous modules in which, for each optical projection system, separate means from one another are used to contribute both to the creation of a first light function and to the creation of a second light function, the means used to contribute to the creation of the second light function being deactivated when the means used to contribute to the creation of the first light function are active, and vice versa.

When, within the first luminous unit or within the additional luminous unit, the means used to contribute to the creation of the first light function are active, the optical projection system associated with this luminous unit is illuminated, and when, alternatively, it is the means used to contribute to the creation of the second light function that are active, the optical projection system associated with this luminous unit is also illuminated, but without it being necessary for other means to contribute than those associated with this second light function.

It should be noted that, for each embodiment, the number of additional luminous units could vary without departing from the context of the invention, and so the luminous module according to the invention could comprise at least three luminous units, each equipped with a luminous assembly and with an optical projection system forming a part of the optical projection element.

According to one feature of the invention, the light rays emitted by the luminous assembly or assemblies of a luminous unit are projected only by the optical projection system of said luminous unit.

According to different features of the invention, the light sources of a luminous unit may be disposed on one and the same support. For example, this support may consist of a printed circuit board. The light sources of all of the luminous units may be disposed on one and the same support.

According to one feature of the invention, the luminous module comprises a printed circuit board bearing all of the light sources. The printed circuit board is configured to make it possible to control the functioning of the light sources, for example following a manual command made by a user of the vehicle, and consequently to turn on or turn off one or the other of the light sources. The use of only one printed circuit board for all of the light sources makes it possible to simplify assembly and the problem of assembly clearances and positioning tolerances which results from one light source to another.

According to one feature of the invention, the printed circuit board has an inclination of between 5° and 15° with respect to a plane perpendicular to the vertical direction. The light sources disposed closest to the optical projection system are thus higher up than the light sources disposed farther away from the optical projection system. Such an inclination makes it possible to position the light sources closer to their respective optical devices. This then generates reflection of a greater number of light rays and thus improves the intensity of the light beams output from the transparent optical component.

According to one feature of the invention, each optical device, or, respectively, each additional optical device, of a luminous assembly comprises at least one collector having a reflective surface designed to collect and reflect the light rays emitted by the light source, or, respectively, by the additional light source, of the luminous assembly, the light rays reflected by the reflective surface of the collector and forming one of the light beams, or, respectively, one of the additional light beams, being directed toward the optical projection system of the luminous unit comprising the luminous assembly.

According to one feature of the invention, the optical projection system of each luminous unit is designed to form an image of the reflective surface of at least one collector of the luminous unit in order to generate at least one of the first and second projected beams, or, respectively, the first additional projected beam or at least one of the first and second additional projected beams.

According to one feature of the invention, said at least one collector comprises the collector of the first optical device and/or the collector of the first additional optical device, and the collector of the first optical device and/or the collector of the first additional optical device has/have a rear end edge arranged in the vicinity of an optical focal point of the optical projection system of the first luminous unit, or, respectively, of the optical projection system of the additional luminous unit.

According to one feature of the invention, the optical focal point of the optical projection system of the first luminous unit, or, respectively, of the optical projection system of the additional luminous unit, is disposed at a distance less than or equal to 10 mm from the rear end edge of the collector of the first optical device, or, respectively, of the collector of the first additional optical device.

Within a first luminous unit or within an additional luminous unit, the positioning of the optical focal point of the optical projection system of the luminous unit with respect to the first optical device and more particular next to a rear end edge of the reflective surface of the collector of the first optical device, and, where appropriate, at a distance of less than 10 mm, makes it possible to ensure the formation of a first light beam at the clean cutoff edge, by imaging of this rear end edge forming the upper part of the beam projected onto the road.

According to one feature of the invention, within a first luminous unit and/or, respectively, within an additional luminous unit, the optical device or devices of the first luminous assembly, or, respectively, of the first additional luminous assembly, is/are offset longitudinally with respect to the optical device or devices of the second luminous assembly, or, respectively, of the second additional luminous assembly, the optical focal point of the optical projection system being disposed longitudinally between the rear end edge of the collector or collectors of the first luminous assembly, or, respectively, of the collector or collectors of the first additional luminous assembly, and the collector or collectors of the second luminous assembly, or, respectively, the collector or collectors of the second additional luminous assembly.

According to one feature of the invention, within a first luminous unit, and/or, respectively, within an additional luminous unit, the optical focal point of the optical projection system is disposed longitudinally between the rear end edge of the optical device or devices of the first luminous assembly, or, respectively, of the first additional luminous assembly, and the rear edge of the optical device or devices of the second luminous assembly, or, respectively, of the second additional luminous assembly.

According to one feature of the invention, in order to avoid, within a first luminous unit or within an additional luminous unit, a situation in which the optical device disposed longitudinally closest to the optical projection system impedes the propagation of the light rays diverted by another optical device to the optical projection system, the optical device farthest away from the optical projection system along the longitudinal direction is also offset at least along the vertical direction, being, in particular, closer to the printed circuit board than the other optical device is.

According to one feature of the invention, within a first luminous unit, and/or, respectively, within an additional luminous unit, the optical device or devices of the first luminous assembly, or, respectively, of the first additional luminous assembly, are offset with respect to the optical device or devices of the second luminous assembly, or, respectively, of the second additional luminous assembly, along a transverse direction perpendicular to the longitudinal direction of the optical axis of the optical projection system.

According to one feature of the invention, within a first luminous unit and/or, respectively, within an additional luminous unit, the optical devices of a luminous assembly are offset transversely, i.e. along a direction perpendicular to the optical axis, with respect to the optical devices of another luminous assembly. Additionally, the optical devices of the first luminous assembly, or, respectively, of the first additional luminous assembly, may be disposed on either side of the optical device or devices of the second luminous assembly, or, respectively, of the second additional luminous assembly, along said transverse direction.

According to one feature of the invention, the collector or collectors of the first luminous assembly of the first luminous unit and/or, respectively, the collector or collectors of the first additional luminous assembly of the additional luminous unit is/are offset with respect to the collector or collectors of the second luminous assembly of the first luminous unit, or, respectively, with respect to the collector or collectors of the second additional luminous assembly of the additional luminous unit, along a transverse direction perpendicular to the longitudinal direction of the optical axis of the projection lens of the first luminous unit, or, respectively, of the additional luminous unit.

According to one feature of the invention, the first light function may, for example, be a regulatory low-beam function or only a part of a regulatory low-beam function. In the latter case, it is possible to have one or more other modules in the vehicle, which supplement the first light function in order to form a regulatory low beam.

According to one feature of the invention, the first luminous assembly is configured such that the first projected beam and/or the first additional projected beam has an upper cutoff edge formed by the imaging of the rear end edge of the corresponding optical device.

According to one feature of the invention, the second light function may, for example, be a regulatory high-beam function or only a part of a regulatory high-beam function. In a similar way to what has just been described, in the latter case, it is possible to have one or more other modules in the vehicle, which supplement the second light function in order to form a regulatory high beam.

In a first example corresponding to the first embodiment, the high-beam function may be created by supplementing the low-beam function. In this case, the light sources associated with the creation of the low-beam function are also involved in the creation of the high-beam function. In particular, only the combination of the first projected beam and of the first additional projected beam forms the low-beam function, and the combination of the first projected beam, of the first additional projected beam, of the second projected beam and, where necessary, of the second additional projected beam forms the high-beam function. In this example, the second projected beam, and, where necessary, the second additional projected beam, form(s) a complementary high beam.

### BRIEF DESCRIPTION OF DRAWINGS

In a second example corresponding to the second embodiment, the high-beam function may be created by independently of the low-beam function. In this case, when the light sources associated with the creation of the high-beam function are activated, the light sources associated with the creation of the low-beam function are deactivated. In particular, only the combination of the first projected beam and of the first additional projected beam forms the low-beam function, and only the combination of the second projected beam and, where necessary, of the second additional projected beam forms the high-beam function. Further features and advantages of the invention will also become apparent both from the following description and from a number of exemplary embodiments given by way of nonlimiting indication with reference to the attached schematic drawings, in which:

FIG. 1 is a depiction of a luminous module according to the invention, in which the optical projection element is formed by the juxtaposition of a plurality of projection lenses,

FIG. 2 is a depiction of a luminous module according to the invention, in which the optical projection element is formed by the juxtaposition of a plurality of projection mirrors,

FIG. 3 shows the luminous module in FIG. 1 according to a first embodiment, in a perspective view revealing a transparent optical projection unit formed of the plurality of juxtaposed projection lenses, a printed circuit board and a plurality of collectors that each form an optical device associated with light sources which are not visible here and are fastened to the printed circuit board,

FIG. 4 shows a top view of the luminous module in FIG. 3,

FIG. 5 shows a view similar to the one in FIG. 3, and illustrates the luminous module in FIG. 1 according to a variant of the first embodiment, and according to a second embodiment,

FIG. 6 shows a top view of the luminous module in FIG. 5,

FIG. 7 shows an embodiment variant of the first embodiment of the luminous module according to the invention,

FIG. 8 shows a view in cross section of one of the luminous units equipping a luminous module according to the invention.

### DETAILED DESCRIPTION OF THE INVENTION

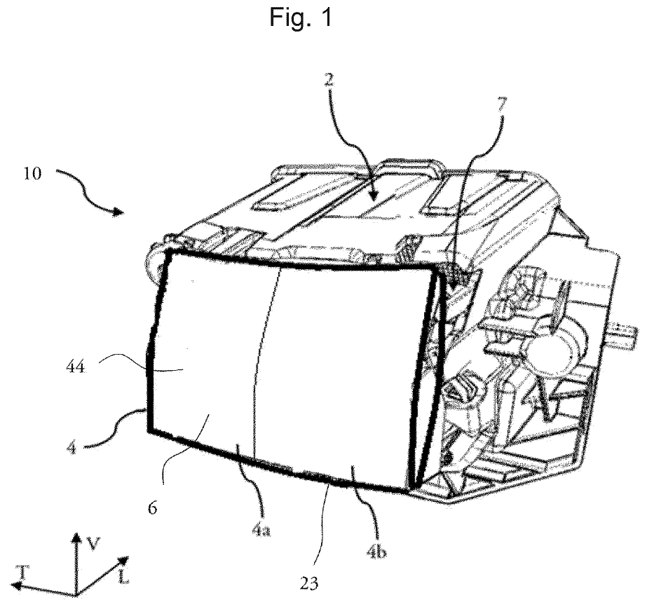

FIG. 1 is an overall view of a luminous module 10 according to the invention. The luminous module 10 may, for example, be incorporated into an automotive vehicle, for example into a headlamp of the automotive vehicle, in order to fulfill at least one illumination function when said vehicle is running. In this regard, the luminous module 10 may, in particular, be arranged at the front of the vehicle.

The luminous module 10 is housed in a mask 2. The luminous module 10 is configured to carry out a plurality of light functions or at the very least to contribute to the emission of a plurality of illumination functions onto the road. The luminous module 10 ensures the emission and the propagation of light beams until they pass through an optical projection element 44.

In the example in FIG. 1, the optical projection element 44 is formed of an optical projection unit 4 that closes the mask 2. The optical projection unit 4 is formed of a plurality of projection lenses 6, 23.

As will be described in more detail below, the luminous module 10 comprises a plurality of luminous units that ensure or contribute to the emission, through the luminous module 10, of at least two light functions, and more particular of at least two illumination functions.

The optical projection unit 4 is divided into a plurality of portions 4a, 4b. In the example in FIG. 1, each luminous unit of the luminous module 10 comprises a projection lens 6, 23. Each portion 4a, 4b of the optical projection unit 4 is then formed by the projection lens 6, 23 of a luminous unit of the luminous module.

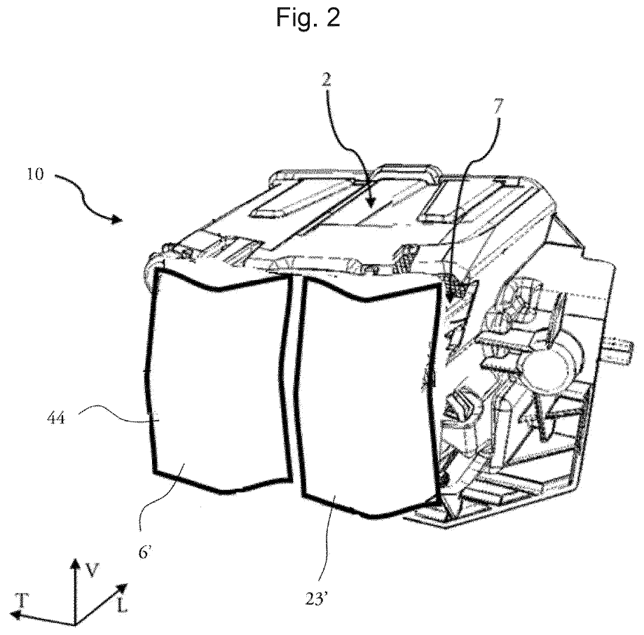

Alternatively, as illustrated in the example in FIG. 2, the optical projection element 44 may be formed by a plurality of projection mirrors 6′, 23′. In this example, each luminous unit of the luminous module 10 comprises a projection mirror 6′, 23′ rather than the projection lens. The optical projection element 44 of the luminous module is then formed by the set of projection mirrors 6′, 23′.

The mask 2 is configured to at least partially house the luminous module 10 according to the invention. This mask 2 has an opening 7 which covers the optical projection element 44, and the luminous module 10 is configured to direct the light rays emitted in the direction of this opening 7. The light rays are then either transmitted through the optical projection unit 4 or reflected by the projection mirrors 6′, 23′.

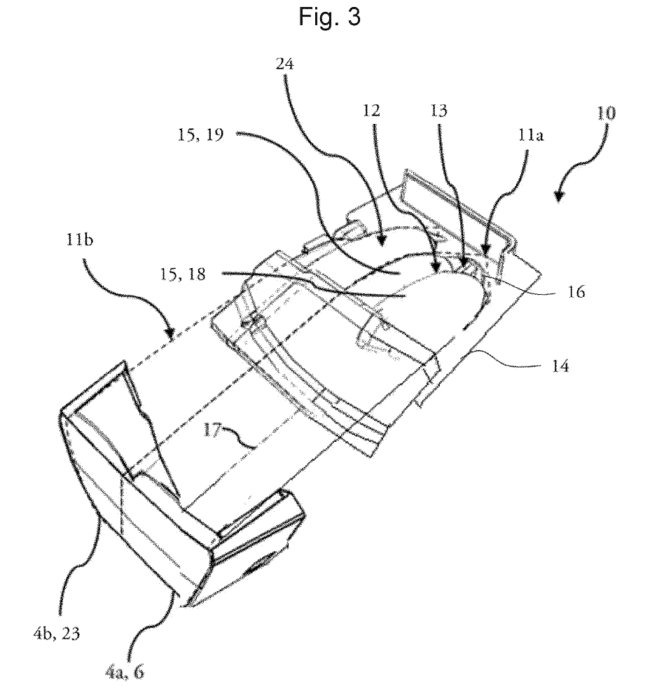

In the rest of the description, the luminous module according to the invention is described on the basis of the luminous module shown in FIG. 1, that is to say on the basis of a luminous module comprising an optical projection unit 4 as optical projection element 44. It will be understood that the description that follows applies in the same way to a luminous module comprising a plurality of projection mirrors for forming the optical projection element 44. In particular, all the features described with reference to FIGS. 3-8 apply in the same way to the luminous module in FIG. 2, except that the features described for the projection lens apply to the projection mirrors.

The luminous module according to the invention is configured to emit a first light function and a second light function in a non-simultaneous manner. The first light function may, for example, be a regulatory low-beam function, and the second light function may, for example, be a regulatory high-beam function. The luminous units are configured, within the luminous module, to ensure or contribute to the emission of this first light function and of this second light function.

According to the invention, the luminous units are arranged such that each optical projection system of the optical projection assembly is illuminated both when the first light function is emitted and when the second light function is emitted.

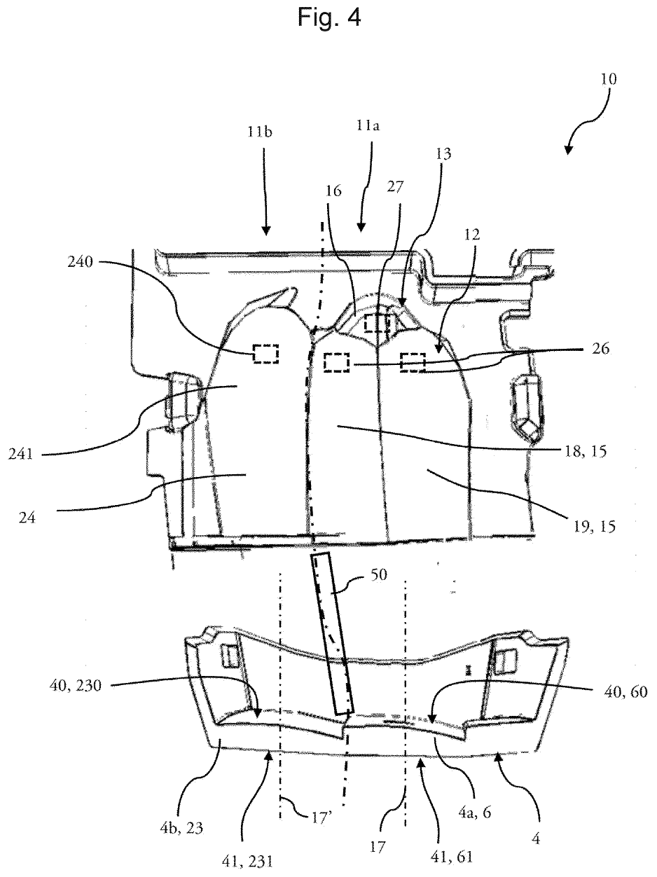

FIGS. 3 and 4 show the luminous module from FIG. 1, from which the mask 2 has been removed, in a first variant of a first embodiment.

The luminous module of this first embodiment comprises a first luminous unit 11a and an additional luminous unit 11b.

The first luminous unit 11a comprises a first luminous assembly 12, a second luminous assembly 13, and a first optical projection system formed by a first projection lens 6, it being understood that it could be formed by a first projection mirror 6′. The first projection lens 6 receives the light rays emitted by the first and second luminous assemblies 12, 13. As described above, the first projection lens 6 is incorporated into the optical projection unit 4 and corresponds to the first portion 4a of the optical projection unit 4.

Each luminous assembly 12, 13 of the first luminous unit 11a comprises a light source and a collector forming an optical device. In addition, each of the luminous assemblies 12, 13 at least partially ensures a light function inherent thereto within the first luminous unit 11a. This first luminous unit 11a may thus help to generate a plurality of light functions in as compact a manner as possible.

More particularly, the first luminous assembly 12 of the first luminous unit 11a comprises first light sources 26, shown by way of dashed lines in FIG. 4, and a first optical device 15, while the second luminous assembly 13 comprises a second light source 27, also shown by way of dashed lines in FIG. 4, and a second optical device 16. The first and second light sources 26, 27 are connected to at least one printed circuit board 14.

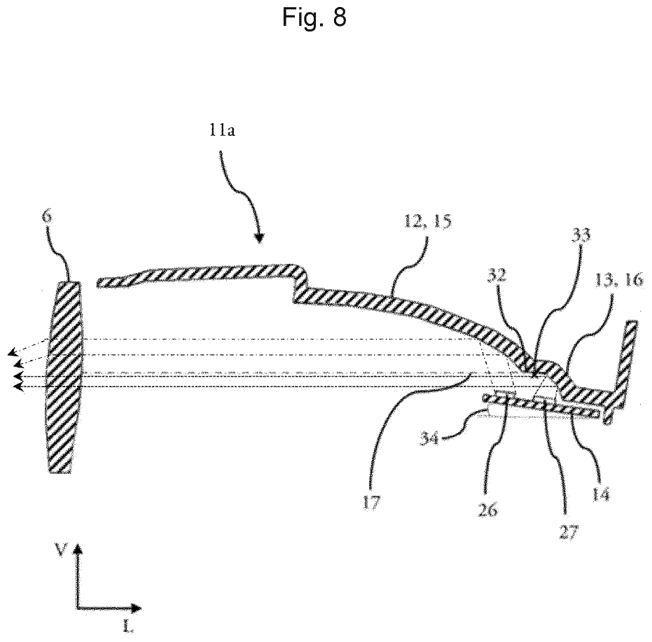

Each of the optical devices 15, 16 has the function of collecting and reflecting the light rays emitted by the light source that is inherent thereto. The first optical device 15 thus forms a first light beam from the light rays emitted by the first light sources 26, and the second optical device 16 thus forms a second light beam from the light rays emitted by the second light source 27. As is shown in FIGS. 3 and 4, the first optical device 15 and the second optical device 16 exhibit an offset with respect to one another, at least along the longitudinal direction L, with the second optical device 16 being arranged behind the first optical device 15. In other words, a distance between the first projection lens 6 and the second optical device 16 is therefore greater than a distance between the first projection lens 6 and the first optical device 15. The advantage of such positioning of the optical devices will be described in particular with reference to the view in cross section in FIG. 8, for example, but it should be noted that such positioning does not limit the invention, given that each luminous assembly within the first luminous unit 11a is able to illuminate in turn the first projection lens 6.

In the example illustrated in FIGS. 3 and 4, the first optical device 15 is divided into a first collector 18 having a reflective surface and a second collector 19 having a reflective surface. The first and second collectors 18, 19 are offset with respect to one another along a transverse direction T, perpendicular to the longitudinal direction L. The first and second collectors 18, 19 form the first optical device 15. Both of the reflective surfaces collect and reflect light rays emitted by the first light sources 26 in order to generate the first light beam.

The second optical device 16 comprises a single collector having a reflective surface. The reflective surface of the collector collects and reflects the light rays emitted by the second light source 27 in order to generate the second light beam.

In order to project the first and second light beams, the first projection lens 6 of the first luminous unit 11a is disposed next to the set of collectors of the first and second optical devices 15, 16 of the first luminous unit 11a.

The arrangement of the luminous assemblies that is illustrated in FIGS. 3 and 4, and in particular the shape of the first and second optical devices 15, 16, does not limit the invention. The luminous module could comprise optical devices with more or fewer collectors, or collectors arranged differently, without departing from the scope of the invention.

The first projection lens 6 is arranged so as to face the light rays emitted by the first luminous assembly 12 and by the second luminous assembly 13. The projection lens 6 has an optical axis 17 extending along a longitudinal direction L. The first projection lens 6 makes it possible to project the first light beam resulting from the first luminous assembly 12 as a first projected light beam, and the second light beam resulting from the second luminous assembly 13 as a second projected light beam.

The first projection lens 6 has an external face 61, facing away from the luminous assemblies 12, 13, which helps to form an exit face 41 of the optical projection unit 4, via which face the projected beams ensure or help to ensure a light function, and an internal face 60, via which the light rays pass into the first projection lens 6.

The first and second projected light beams exit the first luminous unit 11a via the external face 61 of the projection lens 6.

These first and second projected light beams exit the first projection lens 6, depending on the activation of one and/or the other of the luminous assemblies 12, 13, illuminating the first projection lens 6.

The additional luminous unit 11b comprises an additional luminous assembly 24 provided with an additional light source 240, an additional optical device 241, and an additional optical projection system formed by an additional projection lens 23, it being understood that it could be formed by an additional projection mirror 23′. The additional projection lens 23 receives the light rays emitted by the additional luminous assembly 24. As described above, the additional projection lens 23 is incorporated into the optical projection unit 4 and corresponds to the second portion 4b of the optical projection unit 4.

The additional light source is positioned on the same printed circuit board 14 as the first and second sources 26, 27.

The first additional optical device 241 is in the form of a single collector. The additional optical device 241 could comprise a plurality of collectors without departing from the scope of the invention.

The first additional optical device 241 is designed to receive light rays emitted by the first additional light source 240 and to form a first additional light beam from these light rays. This first additional light beam is directed toward the additional projection lens 23. This additional projection lens 23 is configured to convert this first additional light beam into a first additional projected light beam.

The additional projection lens 23 is configured to have an optical axis 17′ extending along a longitudinal direction L.

The additional projection lens 23 has an external face 231, facing away from the single additional luminous assembly 24, which helps to form the abovementioned exit face 41 of the optical projection unit 4, via which face the first additional projected light beam ensures or helps to ensure the first light function, and an internal face 230, via which the light rays pass into the additional projection lens 23.

The additional projection lens 23 of the additional luminous unit 11b makes it possible to project a first additional projected light beam from the first additional light beam. The first additional projected light beam exits the first additional luminous unit 11b via the external face 231 of the additional projection lens 23.

As shown in FIG. 4, a partition 50 is provided substantially longitudinally, i.e.

substantially parallel to the light beams in the direction of the optical projection unit 4, between the first luminous unit 11a and the additional luminous unit 11b, which are adjacent to one another. The partition 50 is configured to form a separating wall between the two luminous units 11a, 11b, in order to prevent the undesirable passage of light rays from one adjacent luminous unit to the other. The partition 50 extends in this case from the luminous assemblies of each of these units to the optical projection unit 4.

The optical projection unit 4 is formed of the juxtaposition of the first projection lens 6 and of the additional projection lens 23. It is notable that the transparent optical component 4 has a continuous and smooth exit face 41, formed by the continuity of the external face 60 of the first projection lens 6 and of the external face 230 of the additional projection lens 23, and an entry face 40 that is likewise continuous, but in this case with separate successive profiles, and is formed successively by the internal face 60 of the first projection lens 6 and by the internal face 230 of the additional projection lens 23.

In this first embodiment, the first light function is created via the combination of the first projected light beam and of the first additional projected light beam, and the second light function is created via the combination of the first projected light beam and of the first additional projected light beam with the second projected light beam. In this first embodiment, the second projected light beam does not make it possible to create the second light function without the addition of the first projected light beams that serve to create the first light function. The second projected light beam has an effect complementary to that of the first projected light beam and first additional projected light beam in order to form the second light function.

As a result of the above, the luminous units of this first embodiment of a luminous module according to the invention are arranged such that the two projection lenses forming the optical projection unit 4, in this case the first projection lens 6 and the additional projection lens 23, are illuminated both:
when the first light function is emitted, via the combination of the first projected light beam exiting the first projection lens 6 and of the first additional projected light beam exiting the additional projection lens 23,
and when the second light function is emitted, via the combination of the first projected light beam and of the second projected light beam exiting the first projection lens 6 and of the first additional projected light beam exiting the additional projection lens 23.

It will be noted that if the luminous module had a first projection mirror 6′ instead of the first projection lens 6, and an additional projection mirror 23′ instead of the additional projection lens 23, the surface of the first projection mirror 6′ and the surface of the additional projection mirror 23′ would both be illuminated both during the emission of the first light function and during the emission of the second light function.

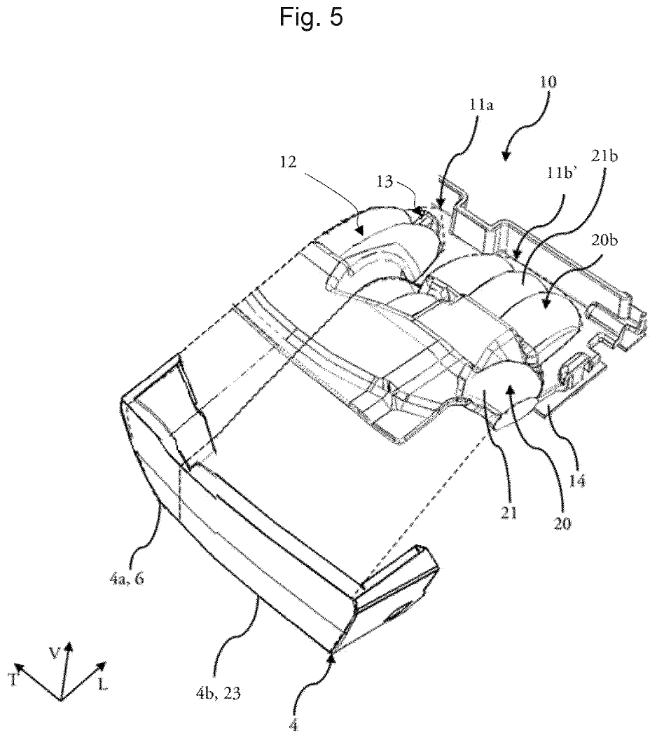

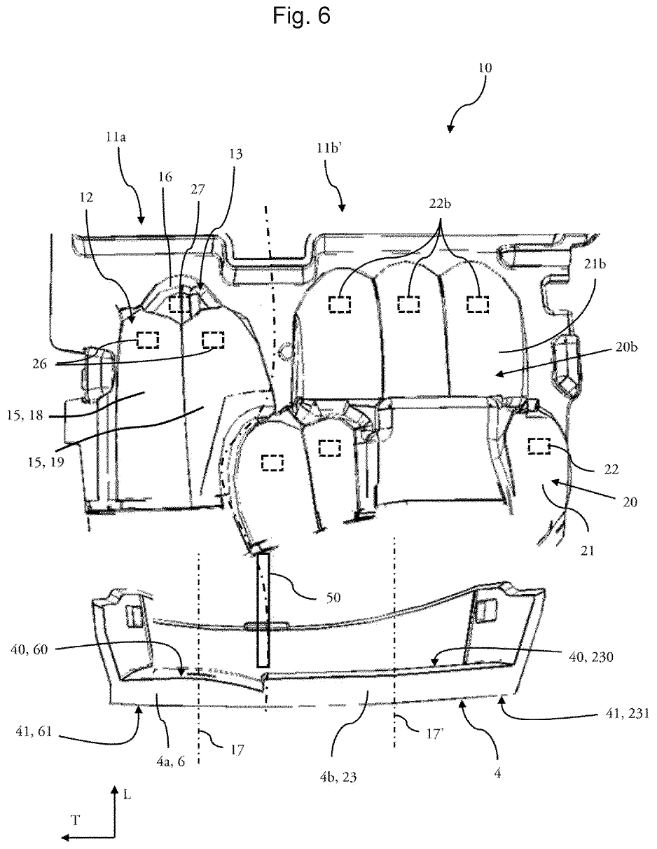

A second embodiment variant of the first embodiment is illustrated in FIGS. 5 and 6. In this second embodiment variant of the first embodiment, the luminous module comprises a first luminous unit 11a identical to the first luminous unit 11a of the first variant of the first embodiment, and an additional luminous unit 11b′, which differs from the additional luminous unit 11b of the first variant of the first embodiment.

Since the first luminous unit 11a shown in FIGS. 5 and 6 is identical to the one shown in FIGS. 3 and 4, the description of the first luminous unit 11a given above with reference to FIGS. 3 and 4 applies to the first luminous unit 11a in FIGS. 5 and 6 and will not be repeated.

The additional luminous unit 11b′ differs from the additional luminous unit 11b in FIGS. 3 and 4 in that it comprises a first additional luminous assembly 20 and a second additional luminous assembly 20b instead of the single additional luminous assembly 24. The other features of the luminous module are identical. Thus, just like the additional luminous unit 11b, the additional luminous unit 11b′ comprises the additional projection lens 23 as projection system, it being understood that this additional projection lens could be replaced by the additional projection mirror 23′. The luminous module also comprises a partition 50 provided substantially longitudinally between the first luminous unit 11a and the additional luminous unit 11b′ so as to form a separating wall between the two luminous units 11a, 11b', in order to prevent the undesirable passage of light rays from one adjacent luminous unit to the other.

The first additional luminous assembly 20 comprises first additional light sources 22 and a first additional optical device 21 designed to receive light rays emitted by the first additional light sources 22 and to form a first additional light beam from these light rays.

The second additional luminous assembly 20b comprises second additional light sources 22b and a second additional optical device 21b designed to receive light rays emitted by the second additional light sources 22b and to form a second additional light beam from these light rays.

The first additional light sources 22 and the second additional light sources 22b are disposed on the same printed circuit board 14 as the first and second light sources 26, 27 of the first luminous unit 11a.

The first and second additional light beams are directed toward the additional projection lens 23, corresponding to the second portion 4b of the optical projection unit 4. This additional projection lens 23 is disposed next to the components of the first additional luminous assembly 20 and of the second additional luminous assembly 20b.

In the example illustrated, the first additional optical device 20 and the second additional optical device 21b each comprise a plurality of collectors. The collectors forming the second additional optical device 21b are offset longitudinally and transversely with respect to the collectors forming the first additional optical device 21 in order not to impede the propagation of the light rays in the direction of the same additional projection lens 23.

The arrangement illustrated here in FIGS. 5 and 6 between the additional luminous assemblies does not limit the invention provided that each of the additional luminous assemblies can illuminate the additional projection lens 23 when the light sources associated with one of the assemblies are activated. In particular, the first and second additional optical devices could comprise more or fewer collectors, and, for example, each comprise only one collector, or the collectors could be disposed in a different way.

The additional projection lens 23 of the additional luminous unit 11b makes it possible to project a first additional projected light beam from the first additional light beam, or a second additional projected light beam from the second additional light beam. The first and second additional projected light beams exit the first additional luminous unit 11b via the external face 231 of the additional projection lens 23.

These first and second additional projected light beams exit the additional projection lens 23, depending on the activation of one and/or the other of the additional luminous assemblies 20, 20b, illuminating the additional projection lens 23.

Just like in the first variant of the first embodiment, the first light function is created via the combination of the first projected light beam and of the first additional projected light beam, and the second light function is obtained via the combination of the first projected light beam and of the first additional projected light beam with the second projected light beam, to which the second additional projected light beam is added. In a similar way to the first variant of the first embodiment, the second projected light beam and, in this case, the second additional projected light beam do not make it possible to create the second light function without the addition of the first projected light beams that serve to create the first light function. The second projected light beam and, in this case, the second additional projected light beam have an effect complementary to that of the first projected light beam and first additional projected light beam in order to form the second light function.

It will be understood that, as a result, it is also possible to conclude here that the luminous units of this exemplary embodiment of a luminous module according to the invention are arranged such that the two projection lenses forming the optical projection unit 4, in this case the projection lens 6 and the additional projection lens 23, are illuminated both:
when the first light function is emitted, via the combination of the first projected light beam exiting the first projection lens 6 and of the first additional projected light beam exiting the additional projection lens 23,
and when the second light function is emitted, via the combination of the first projected light beam and of the second projected light beam exiting the first projection lens 6 and of the first additional projected light beam and of the second additional projected light beam exiting the additional projection lens 23.

It will be noted that if the luminous module had a first projection mirror 6′ instead of the first projection lens 6, and an additional projection mirror 23′ instead of the additional projection lens 23, the surface of the first projection mirror 6′ and the surface of the additional projection mirror 23′ would both be illuminated both during the emission of the first light function and during the emission of the second light function.

A second embodiment of the invention may also be depicted by FIGS. 5 and 6. In this embodiment, the disposition of the first luminous unit 11a and of the additional luminous unit 11b′ is identical to that of the second variant of the first embodiment, and only the control of the light sources 26, 27, 22, 22b of the luminous units differs from the second embodiment variant of the first embodiment.

Unlike the first embodiment, in the second embodiment, the second light function is formed only via the contribution of the second projected light beam and of the second additional projected light beam. The first light beam and the first additional projected light beam do not help to form the second light function.

In particular, the first and second projected light beams do not exit the first projection lens 6 simultaneously, depending on the activation of one or the other of the luminous assemblies 12, 13, illuminating the first projection lens 6. In addition, the first and second additional projected light beams do not exit the additional projection lens 23 simultaneously, depending on the activation of one or the other of the additional luminous assemblies 20, 20b, illuminating the additional projection lens 23.

Thus, by virtue of the specific configuration of the first luminous unit 11a, which comprises both a first luminous assembly 12 contributing to the first light function and a second luminous assembly 13 contributing to the second light function, and by virtue of the specific configuration of the additional luminous unit 11b′, which comprises both a first additional luminous assembly 20 contributing to the first light function and a second additional luminous assembly 20b contributing to the second light function, the first projection lens 6 and the additional projection lens 23 are both illuminated both during the emission of the first light function and during the emission of the second light function.

As a result of the above, the luminous units 11a, 11b′ of this second embodiment of a luminous module according to the invention are arranged such that the two projection lenses forming the optical projection unit 4, in this case the first projection lens 6 and the additional projection lens 23, are illuminated both:
when the first light function is emitted, via the combination of the first projected light beam exiting the first projection lens 6 and of the first additional projected light beam exiting the additional projection lens 23,
and when the second light function is emitted, via the combination of the second projected light beam exiting the first projection lens 6 and of the second additional projected light beam exiting the additional projection lens 23.

It will be noted that if the luminous module had a first projection mirror 6′ instead of the first projection lens 6, and an additional projection mirror 23′ instead of the additional projection lens 23, the surface of the first projection mirror 6′ and the surface of the additional projection mirror 23′ would both be illuminated both during the emission of the first light function and during the emission of the second light function.

It should be noted that the number of luminous units illustrated in FIGS. 1-6 does not limit the invention and that it is possible to have a different number of luminous units. In particular, the luminous module according to the invention may comprise more than one additional luminous unit.

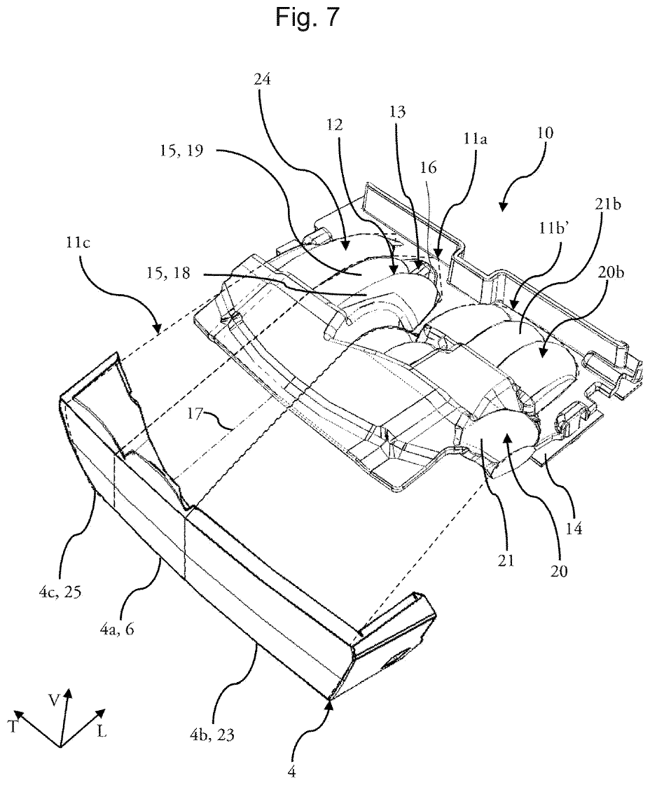

A configuration with three luminous units is illustrated, for example, in FIG. 7. This configuration is compatible with the first embodiment, in which the first light beams are produced simultaneously with the second light beams in order to form the second light function.

In this FIG. 7, the luminous module shown in FIGS. 5 and 6 comprises, in addition to the first luminous unit 11a and the additional luminous unit 11b′, referred to as first additional luminous unit 11b′, a second additional luminous unit 11c. The luminous units are each delimited by dashed lines to make it easier for the reader to understand.

The second additional luminous unit 11c is identical to the additional luminous unit 11b of the first variant of the first embodiment, except that the additional projection lens 23 has been replaced by a second additional projection lens 25. This second additional projection lens 25 is incorporated into the optical projection unit 4 and corresponds to a third portion 4c of the optical projection unit 4.

Thus, each projection lens 6, 23, 25 is illuminated both
when the first light function is emitted, via the combination of the first projected light beam exiting the first projection lens 6 and of the first additional projected light beams exiting the additional projection lens 23 and the second additional projection lens 25,
and when the second light function is emitted, via the combination of the first projected light beam and of the second projected light beam exiting the first projection lens 6 and of the first additional projected light beam and of the second additional projected light beam exiting the additional projection lens 23, and of the first projected light beam exiting the second additional projection lens 25.

A configuration with three luminous units is also conceivable for the second embodiment. In this case, a second additional luminous unit comprising a first additional luminous assembly contributing to the first light function and a second additional luminous assembly contributing to the second light function should then be added to the luminous module illustrated in FIGS. 5 and 6.

FIG. 8 shows more particularly the general arrangement of a luminous unit, in this case the first luminous unit 11a in FIGS. 3-7, with the first and second separate luminous assemblies 12, 13 associated with the first projection lens 6, forming the abovementioned optical projection unit 4.

FIG. 8 is a cross section on a plane defined by the longitudinal direction L and a vertical direction V perpendicular to the longitudinal direction L and to the transverse direction T, and passing through the second light source 27 of the second luminous assembly 13 of the first luminous unit 11a, this view in cross section also showing, in the background, a first light source 26 of the first luminous assembly 12 of this same luminous unit 11a.

The first light source 26 is disposed next to the first optical device 15, forming part of the first luminous assembly, and the second light source 27 is disposed next to the second optical device 16, forming part of the second luminous assembly.

When activated, the first light source 26 emits first light rays which propagate to the reflective surface of the first optical device 15 and are collected and reflected by the latter in order to form the first light beam, emitted in the direction of the first projection lens 6. The first light beam is then projected by the first projection lens 6. The second light source 27 emits second light rays which propagate to the reflective surface of the second optical device 16 and are collected and reflected by the latter in order to form the second light beam, emitted in the direction of the first projection lens 6. The second light beam is then projected by the first projection lens 6.

Each light source 26, 27 is disposed at a focal point of the reflective surface of the corresponding optical device, such that the rays that it emits are collected and reflected along the optical axis 17 of the first projection lens.

The projection lens 6 is configured such that an optical focal point 33 of this first projection lens 6 is disposed in the vicinity of a rear end edge 32 of the first optical device 15 with respect to the main direction of propagation of the light rays along the optical axis.

The expression “in the vicinity” of the rear end edge 32 of the first optical device 15 means that the distance between this rear end edge 32 and the optical focal point 33 is less than or equal to 10 mm.

As a result of this disposition, at least some of these reflected rays have angles of inclination in a vertical plane with respect to said optical axis 17 that are less than or equal to 25°, preferably less than or equal to 10°, so as to be under what are referred to as Gaussian conditions, making it possible to obtain a stigmatism, that is to say a clearness of the projected image. The rays are advantageously rays reflected by the rear part of the reflective surface of each of the optical devices 15, 16, and in particular rays reflected in the vicinity of the rear end edge 32 of the first optical device 15.

The second optical device 16 is offset with respect to the first optical device 15 along the vertical direction V, the second optical device 16 being closer to the printed circuit board 14 than the first optical device 15 is. This offset allows the propagation of the reflected second light rays without these being obstructed by the first optical device 15.

In the example illustrated, the printed circuit board 14 has an inclination with respect to a plane defined by the longitudinal direction L and the transverse direction. The printed circuit board 14 has an angle of inclination 34 of between 5° and 15° with respect to said plane. This inclination makes it possible to orient the first light source 26 and the second light source 27, respectively, further toward the curvature of the first optical device 15 and of the second optical device 16 in order to promote the reflection of the light rays.

A particular arrangement of two luminous assemblies within one and the same luminous unit was described below with reference to the luminous unit illustrated in FIG. 8, which is more particularly the first luminous unit 11a of the luminous module in FIGS. 3-7, but it should be noted that other arrangements of two separate luminous assemblies, in particular the arrangements illustrated on the additional luminous units in FIGS. 3-7 with, for example, a transverse offset of the optical devices of the luminous assemblies with respect to one another, could be implemented.

Of course, the invention is not limited to the examples that have just been described, and numerous modifications may be made to these examples without departing from the scope of the invention, provided that a luminous module, in accordance with the invention as has just been described, comprises a plurality of optical projection systems forming part of an optical projection element and that the components of this luminous module are configured so as to be able to generate separate light functions and such that the optical projection systems of the optical projection element are illuminated both when the first light function is emitted and when the second light function is emitted.

What is claimed is:

1. An automotive-vehicle luminous module configured to emit a first light function and a second light function in a non-simultaneous manner, and comprising:
an optical projection element formed of a plurality of optical projection systems,
a plurality of luminous units each luminous unit including:
at least one luminous assembly, and
an optical projection system that belongs to the plurality of optical projection systems and receives the light rays emitted by the luminous assembly or assemblies of the corresponding luminous unit,
the luminous units being arranged such that each optical projection system of the optical projection element is illuminated when the first light function is emitted and when the second light function is emitted.

2. The automotive-vehicle luminous module as claimed in claim 1, wherein a partition is disposed between two adjacent luminous units.

3. The automotive-vehicle luminous module as claimed in claim 1, wherein the optical projection system of each luminous unit is formed by a projection lens the projection lenses being juxtaposed and forming a transparent and one-piece optical projection unit, the optical projection unit forming the optical projection element.

4. The automotive-vehicle luminous module as claimed in claim 1, wherein the plurality of luminous units includes a first luminous unit and an additional luminous unit,
the at least one luminous assembly of the first luminous unit includes:
a first luminous assembly formed of at least one first light source and of a first optical device designed to receive light rays emitted by the first light source and to form a first light beam from these light rays,
a second luminous assembly formed of at least one second light source and of a second optical device designed to receive light rays emitted by the second light source and to form a second light beam from these light rays,
and the optical projection system of the first luminous unit referred to as first optical projection system, being designed to project the first light beam as a first projected beam and the second light beam as a second projected beam,
the at least one luminous assembly of the additional luminous unit includes:
a first additional luminous assembly formed of at least one first additional light source and of a first additional optical device designed to receive light rays emitted by the first additional light source and to form a first additional light beam from these light rays,
and the optical projection system of the additional luminous unit, referred to as additional optical projection system, being designed to project the first additional light beam as a first additional projected beam,
the combination of the first projected beam and of the first additional projected beam forming the first light function and the combination of the first projected beam, of the first additional projected beam and of the second projected beam forming the second light function.

5. The automotive-vehicle luminous module as claimed in claim 4, wherein the additional luminous unit also includes a second additional luminous assembly formed of at least one second additional light source and of a second additional optical device designed to receive light rays emitted by the second additional light source and to form a second additional light beam from these light rays,
and the optical projection system of the additional luminous unit, referred to as additional optical projection system, being designed to project the second additional light beam as a second additional projected beam,
the second additional projected beam being combined with the combination of the first projected beam, of the first additional projected beam and of the second projected beam in order to form the second light function.

6. The automotive-vehicle luminous module as claimed in claim 1, wherein the plurality of luminous units include a first luminous unit and an additional luminous unit,
the at least one luminous assembly of the first luminous unit includes:
a first luminous assembly formed of at least one first light source and of a first optical device designed to receive light rays emitted by the first light source and to form a first light beam from these light rays,
a second luminous assembly formed of at least one second light source and of a second optical device designed to receive light rays emitted by the second light source and to form a second light beam from these light rays,
and the optical projection system of the first luminous unit, referred to as first optical projection system, being designed to project the first light beam as a first projected beam and the second light beam as a second projected beam;
the at least one luminous assembly of the additional luminous unit includes:
a first additional luminous assembly formed of at least one first additional light source and of a first additional optical device designed to receive light rays emitted by the first additional light source and to form a first additional light beam from these light rays,
a second additional luminous assembly formed of at least one second additional light source and of a second additional optical device designed to receive light rays emitted by the second additional light source and to form a second additional light beam from these light rays,
and the optical projection system of the additional luminous unit, referred to as additional optical projection system, being designed to project the first additional light beam as a first additional projected beam and the second additional light beam as a second additional projected beam,
the combination of the first projected beam and of the first additional projected beam forming the first light function, and the combination of the second projected beam and of the second additional projected beam forming the second light function.

7. The automotive-vehicle luminous module as claimed claim 4, wherein the light sources of a luminous unit, are disposed on one and the same support.

8. The automotive-vehicle luminous module as claimed in claim 4, wherein each optical device, or, respectively, each additional optical device, of a luminous assembly includes at least one collector having a reflective surface designed to collect and reflect the light rays emitted by the light source, or, respectively, by the additional light source, of the luminous assembly, the light rays reflected by the reflective surface of the collector and forming one of the light beams, or, respectively, one of the additional light beams, being directed toward the optical projection system of the luminous unit comprising the luminous assembly.

9. The automotive-vehicle luminous module as claimed in claim 8, wherein the optical projection system of each luminous unit is designed to form an image of the reflective surface of at least one collector of the luminous unit in order to generate at least one of the first and second projected beams, or, respectively, the first additional projected beam or at least one of the first and second additional projected beams.

10. The automotive-vehicle luminous module as claimed in claim 9, wherein the at least one collector includes the collector of the first optical device and/or the collector of the first additional optical device, and the collector of the first optical device and/or the collector of the first additional optical device has/have a rear end edge arranged in the vicinity of an optical focal point of the optical projection system of the first luminous unit, or, respectively, of the optical projection system of the additional luminous unit.

11. The automotive-vehicle luminous module as claimed in claim 7, wherein the collector or collectors of the first luminous assembly of the first luminous unit and/or, respectively, the collector or collectors of the first additional luminous assembly of the additional luminous unit is/are offset with respect to the collector or collectors of the second luminous assembly of the first luminous unit, or, respectively, with respect to the collector or collectors of the second additional luminous assembly of the additional luminous unit, along a transverse direction perpendicular to the longitudinal direction of the optical axis of the projection lens of the first luminous unit, or, respectively, of the additional luminous unit.
